(19) United States
(12) Patent Application Publication
(10) Pub. No.: US 2025/0296603 A1
(43) Pub. Date: Sep. 25, 2025

(54) METHOD FOR CONTROLLING VEHICLE AND APPARATUS THEREOF

(71) Applicants: Hyundai Motor Company, Seoul (KR); Kia Corporation, Seoul (KR)

(72) Inventors: Sung Kwan Kim, Hwaseong-Si (KR); Su Young Choi, Hwaseong-Si (KR); Sung Woo Choi, Hwaseong-Si (KR); Su Jin Han, Hwaseong-si (KR)

(21) Appl. No.: 18/919,979

(22) Filed: Oct. 18, 2024

(30) Foreign Application Priority Data
Mar. 25, 2024 (KR) 10-2024-0040475

(51) Int. Cl. B60W 60/00

(52) U.S. Cl. CPC B60W 60/0027; B60W 2554/4041; B60W 2554/4044

(57) ABSTRACT

A method performed by a vehicle apparatus may comprise generating a plurality of first candidate sample points based on state information of a moving object. These sample points satisfy first azimuth conditions and a separation distance condition, set according to the moving object's state information. The method may further comprise selecting a first optimal sample point from these candidates based on an optimal sample point condition, goal point information, and the candidate points' information. Subsequently, a plurality of second candidate sample points may be generated, satisfying second azimuth conditions and the separation distance condition, using updated state information derived from the first optimal sample point. A second optimal sample point may be then selected from these candidates. Finally, a driving route may be generated based on both the first and second optimal sample points, and the vehicle may be controlled for autonomous driving based on this driving route.

### CROSS-REFERENCE TO RELATED APPLICATION

This application claims the benefit of priority to Korean Patent Application No. 10-2024-0040475, filed in the Korean Intellectual Property Office on Mar. 25, 2024, the entire contents of which are incorporated herein by reference.

### TECHNICAL FIELD

The present disclosure relates to a method for controlling a vehicle, and an apparatus thereof.

### BACKGROUND

The matters described in this Background section are only for enhancement of understanding of the background of the disclosure, and should not be taken as acknowledgement that they correspond to prior art already known to those skilled in the art. An autonomous driving technology is developing rapidly, and thus the need to efficiently create driving routes emerges.

The driving routes may be generated in consideration of a host vehicle's location and a lane link on precise map information. Accordingly, if there is no precise map information (e.g., if there is no information about the lane link), it is difficult to create a driving route.

Therefore, a method for generating driving routes is being studied even in situations where there is no precise map information.

### SUMMARY

According to the present disclosure, a method performed by an apparatus of a vehicle, the method may comprise generating, based on state information of a moving object, a plurality of first candidate sample points, wherein the plurality of first candidate sample points satisfy a plurality of first azimuth conditions and a separation distance condition, and wherein the plurality of first azimuth conditions and the separation distance condition are set based on the state information of the moving object, based on an optimal sample point condition, information related to a goal point, and information related to the plurality of first candidate sample points, selecting a first optimal sample point from the plurality of first candidate sample points, wherein the first optimal sample point satisfies the optimal sample point condition, generating based on the first optimal sample point, a plurality of second candidate sample points, wherein the plurality of second candidate sample points satisfy a plurality of second azimuth conditions and the separation distance condition, wherein the plurality of second azimuth conditions and the separation distance condition are set based on updated state information, and wherein the updated state information is obtained by updating based on the first optimal sample point, the state information of the moving object, based on the optimal sample point condition, the information related to the goal point, and information related to the plurality of second candidate sample points, selecting a second optimal sample point from the plurality of second candidate sample points, wherein the second optimal sample point satisfies the optimal sample point condition, generating based on the first optimal sample point and the second optimal sample point, a driving route, and controlling based on the driving route, the vehicle for autonomous driving.

The method, wherein the state information of the moving object comprises variable state information, wherein the variable state information comprises location information of the moving object and heading information of the moving object, and fixed state information, wherein the fixed state information comprises length information of the moving object and maximum steering angle information of the moving object.

The method, wherein the generating the plurality of first candidate sample points comprises setting the plurality of first azimuth conditions with reference to turning radius information, wherein the turning radius information is determined based on the fixed state information and the variable state information, and wherein the generating the plurality of second candidate sample points comprises setting the plurality of second azimuth conditions with reference to the turning radius information.

The method, wherein the selecting the first optimal sample point comprises based on first directional information from the plurality of first candidate sample points to the goal point and first heading information at each of the plurality of first candidate sample points, assigning a score to each of the plurality of first candidate sample points, and selecting, based on the score assigned to each of the plurality of first candidate sample points, the first optimal sample point, and wherein the selecting the second optimal sample point comprises based on second directional information from the plurality of second candidate sample points to the goal point and second heading information at each of the plurality of second candidate sample points, assigning a score to each of the plurality of second candidate sample points, and selecting, based on the score assigned to each of the plurality of second candidate sample points, the second optimal sample point.

The method, wherein the selecting the first optimal sample point comprises selecting, based on a first free space region condition, the first optimal sample point, wherein the first free space region condition is determined by using the state information of the moving object, and wherein the first optimal sample point satisfies the first free space region condition, and wherein the selecting the second optimal sample point comprises performing one of selecting, based on a second free space region condition, the second optimal sample point from the plurality of second candidate sample points, wherein the second free space region condition is determined by using the state information of the moving object, and wherein the second optimal sample point satisfies the second free space region condition, or selecting a new first optimal sample point from the plurality of the first candidate sample points.

The method, wherein the selecting the new first optimal sample point comprises based on none of the plurality of second candidate sample points satisfying the second free space region condition selecting the new first optimal sample point from the plurality of the first candidate sample points, wherein the new first optimal sample point satisfies the optimal sample point condition and the first free space region condition, and wherein the new first optimal sample point is different from the first optimal sample point, generating a second plurality of second candidate sample points, wherein the second plurality of second candidate sample points satisfy the plurality of second azimuth conditions and a second separation distance condition, wherein the plurality of second azimuth conditions and the second separation distance condition are set based on second updated state information, and wherein the second updated state information is obtained by updating, based on the new first optimal sample point, the state information of the moving object, and based on the optimal sample point condition, the information related to the goal point, information related to the second plurality of second candidate sample points, and the second free space region condition, selecting a new second optimal sample point from the second plurality of second candidate sample points.

The method, wherein the selecting the second optimal sample point comprises performing one of based on a heading difference value satisfying a threshold range and at least one of the plurality of second candidate sample points being located within a region, selecting the second optimal sample point from the plurality of second candidate sample points, wherein the region is set based on a location of the goal point, and wherein the heading difference value is based on a difference between first heading information at at least one of the plurality of second candidate sample points and second heading information at the goal point, or based on the heading difference value not satisfying the threshold range, selecting a new first optimal sample point from the plurality of first candidate sample points.

The method, wherein the selecting the new first optimal sample point comprises selecting the new first optimal sample point from the plurality of first candidate sample points, wherein the new first optimal sample point satisfies the optimal sample point condition, and wherein the new first optimal sample point is different from the first optimal sample point, generating a second plurality of second candidate sample points, wherein the second plurality of second candidate sample points satisfy the plurality of second azimuth conditions and a second separation distance condition, wherein the plurality of second azimuth conditions and the second separation distance condition are set based on second updated state information, and wherein the second updated state information is obtained by updating based on the new first optimal sample point, the state information of the moving object, and based on the optimal sample point condition, at least one of the second plurality of second candidate sample points being located within the region, and a new heading difference value satisfying the threshold range, selecting a second optimal sample point from the second plurality of second candidate sample points, wherein the new heading difference value is based on a difference between new first heading information at at least one of the second plurality of second candidate sample points and the second heading information at the goal point.

The method, wherein the plurality of first azimuth conditions comprise at least one of −14°, −10°, −7°, −5°, 0°, 5°, 7°, 10°, or 14°.

The method, wherein the separation distance condition comprises a separation distance that the moving object moves from the vehicle.

According to the present disclosure, an apparatus of a vehicle, the apparatus may comprise one or more processors, and memory storing instructions, when executed by the one or more processors, cause the apparatus to generate, based on state information of a moving object, a plurality of first candidate sample points, wherein the plurality of first candidate sample points satisfy a plurality of first azimuth conditions and a separation distance condition, and wherein the plurality of first azimuth conditions and the separation distance condition are set based on the state information of the moving object, generate, based on state information updated based on a first optimal sample point, a plurality of second candidate sample points, wherein the plurality of second candidate sample points satisfy a plurality of second azimuth conditions and the separation distance condition, wherein the plurality of second azimuth conditions and the separation distance condition are set based on updated state information, and wherein the updated state information is obtained by updating based on the first optimal sample point, the state information of the moving object, based on an optimal sample point condition, information related to a goal point, and information related to the plurality of first candidate sample points, select the first optimal sample point from the plurality of first candidate sample points, wherein the first optimal sample point satisfies the optimal sample point condition, based on the optimal sample point condition, the information related to the goal point, and information related to the plurality of second candidate sample points, select a second optimal sample point from the plurality of second candidate sample points, wherein the second optimal sample point satisfies the optimal sample point condition, generate, based on the first optimal sample point and the second optimal sample point, a driving route, and control, based on the driving route, the vehicle for autonomous driving.

The apparatus, wherein the state information of the moving object comprises variable state information, wherein the variable state information comprises location information of the moving object and heading information of the moving object, and fixed state information, wherein the fixed state information comprises length information of the moving object and maximum steering angle information of the moving object.

The apparatus, wherein the instructions, when executed by the one or more processors, further cause the apparatus to set the plurality of first azimuth conditions with reference to turning radius information and the plurality of second azimuth conditions with reference to the turning radius information, wherein the turning radius information is determined based on the fixed state information and the variable state information.

The apparatus, wherein the instructions, when executed by the one or more processors, further cause the apparatus to based on first directional information from the plurality of first candidate sample points to the goal point and first heading information at each of the plurality of first candidate sample points, assign a score to each of the plurality of first candidate sample points and select, based on the score assigned to each of the plurality of first candidate sample points, the first optimal sample point, and based on second directional information from the plurality of second candidate sample points to the goal point and second heading information at each of the plurality of second candidate sample points, assign a score to each of the plurality of second candidate sample points and select, based on the score assigned to each of the plurality of second candidate sample points, the second optimal sample point.

The apparatus, wherein the instructions, when executed by the one or more processors, further cause the apparatus to select, based on a first free space region condition, the first optimal sample point, wherein the first free space region condition is determined by using the state information of the moving object, and wherein the first optimal sample point satisfies the first free space region condition, and select, based on a second free space region condition, the second optimal sample point from the plurality of second candidate sample points, wherein the second free space region condition is determined by using the state information of the moving object, and wherein the second optimal sample point satisfies the second free space region condition.

The apparatus, wherein the instructions, when executed by the one or more processors, further cause the apparatus to, based on none of the plurality of second candidate sample points satisfying the second free space region condition, select a new first optimal sample point from the plurality of the first candidate sample points, wherein the new first optimal sample point satisfies the optimal sample point condition and the first free space region condition, and wherein the new first optimal sample point is different from the first optimal sample point, generate a second plurality of second candidate sample points, wherein the second plurality of second candidate sample points satisfy the plurality of second azimuth conditions and a second separation distance condition, wherein the plurality of second azimuth conditions and the second separation distance condition are set based on second updated state information, and wherein the second updated state information is obtained by updating, based on the new first optimal sample point, the state information of the moving object, and based on the optimal sample point condition, the information related to the goal point, information related to the second plurality of second candidate sample points, and the second free space region condition, select a new second optimal sample point from the second plurality of second candidate sample points.

The apparatus, wherein the instructions, when executed by the one or more processors, further cause the apparatus to, based on a heading difference value satisfying a threshold range and at least one of the plurality of second candidate sample points being located within a region, select the second optimal sample point from the plurality of second candidate sample points, wherein the region is set based on a location of the goal point, and wherein the heading difference value is based on a difference between first heading information at at least one of the plurality of second candidate sample points and second heading information at the goal point.

The apparatus, wherein the instructions, when executed by the one or more processors, further cause the apparatus to, based on the heading difference value not satisfying the threshold range, select a new first optimal sample point from the plurality of first candidate sample points, wherein the new first optimal sample point satisfies the optimal sample point condition, and wherein the new first optimal sample point is different from the first optimal sample point, generate a second plurality of second candidate sample points, wherein the second plurality of second candidate sample points satisfy the plurality of second azimuth conditions and a second separation distance condition, wherein the plurality of second azimuth conditions and the second separation distance condition are set based on second updated state information, and wherein the second updated state information is obtained by updating, based on the new first optimal sample point, the state information of the moving object, and based on the optimal sample point condition, at least one of the second plurality of second candidate sample points being located within the region, and a new heading difference value satisfying the threshold range, select a second optimal sample point from the second plurality of second candidate sample points, wherein the new heading difference value is based on a difference between new first heading information at at least one of the second plurality of second candidate sample points and the second heading information at the goal point.

The apparatus, wherein the plurality of first azimuth conditions comprise at least one of −14°, −10°, −7°, −5°, 0°, 5°, 7°, 10°, or 14°.

The apparatus, wherein the separation distance condition comprises a separation distance that the moving object moves from the vehicle.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of a vehicle control method, according to an example disclosed in this specification;

FIG. 2A and FIG. 2B show an example of a method for generating a plurality of candidate sample points, according to an example disclosed in this specification;

FIG. 3 shows an example of a method for selecting an optimal sample point, according to an example disclosed in this specification;

FIG. 4 shows an example of a method for selecting an optimal sample point if a specific condition is not satisfied;

FIG. 5 shows an example of a vehicle control apparatus, according to an example disclosed in this specification; and

FIG. 6 shows an example of a computing system for executing a vehicle control method, according to an example of the present disclosure.

With regard to description of drawings, the same or similar components will be marked by the same or similar reference signs.

### DETAILED DESCRIPTION

Hereinafter, various examples of the present disclosure will be described in detail with reference to the accompanying drawings, so that those skilled in the art may easily carry out the present disclosure. However, the present disclosure may be embodied in many different forms and should not be construed as limited to the examples set forth herein.

In describing the examples of the present disclosure, if a specific description of the related art is deemed to obscure the subject matter of the examples of the present disclosure, the detailed description will be omitted. In addition, in the drawings, parts that are not related to the description of the present disclosure are omitted, and similar parts are given similar reference numerals.

In the present disclosure, it will be understood that if an element is referred to as being “connected” or “coupled” to another element, it may be directly connected or indirectly connected to another element. In addition, if some part ‘includes’ or “possess” some elements, unless explicitly described to the contrary, it means that other elements may be further included but not excluded.

In the present disclosure, expressions such as “first,” or “second,” and the like, may express their elements regardless of their priority or importance and may be used to distinguish one element from another element but is not limited to these components. Therefore, without departing from the scope of the present disclosure, a first component of one example may be referred to as a second component of another example. Similarly, a second component of one example may be referred to as a first component of another example.

In the present disclosure, components that are distinguished from each other are only for clearly describing characteristics, and do not mean that the components are necessarily separated. That is, a plurality of components may be integrated to form a single hardware or software unit, or a single component may be distributed to form a plurality of hardware or software units. Accordingly, such integrated or distributed examples are included in the scope of the present disclosure, even though not mentioned separately.

In the present disclosure, components described in various examples do not necessarily mean essential components, and some may be optional components. Therefore, an example composed of a subset of components described in an example is also included in the scope of the present disclosure. Moreover, an example in which another component is additionally included in components described in the various examples is also included in the scope of the present disclosure.

In the present disclosure, expressions of positional relationships used herein, such as upper, lower, left, and right are described for convenience of description. If viewing the drawings shown in this specification in reverse, the positional relationship described in the specification may be interpreted in the opposite manner.

In the disclosure, the expressions “A or B”, “at least one of A and B”, “at least one of A or B”, “A, B, or C”, “at least one of A, B, and C”, and “at least one of A, B, or C” may include any and all combinations of one or more of the associated listed items.

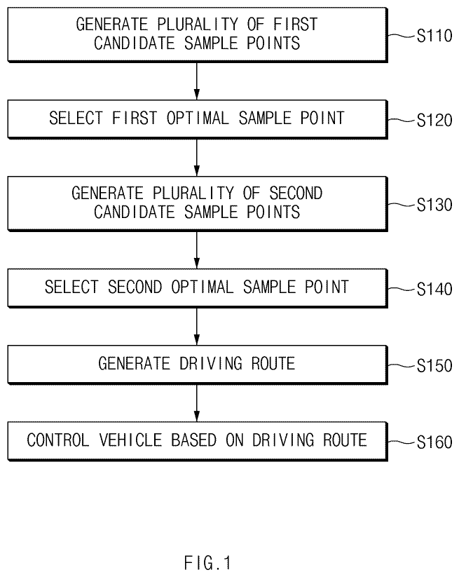

Hereinafter, examples of the present disclosure will be described in detail with reference to FIGS. 1 to 6.

Efficiently creating driving routes may assist autonomous driving of a vehicle. An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the used conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

FIG. 1 shows an example of a vehicle control method, according to an example disclosed in this specification. For convenience, FIG. 19 is described by way of an example in which the steps are performed by a processor (e.g., circuit). One, some, or all steps of the example method of FIG. 1, or portions thereof, may be performed by one or more other circuits. One or some, steps of the example method of FIG. 1 may be omitted, performed in other orders, and/or otherwise modified, and/or one or more additional steps may be added.

Referring to FIG. 1, a point generation device may generate a plurality of first candidate sample points that satisfy a plurality of first azimuth conditions and a separation distance condition, which are set based on state information of a moving object (e.g., vehicle) (S110). Azimuth describes an angular measurement of a direction on a horizontal plane, for example, measured in degrees from a reference direction, for example, true north (e.g., an azimuth of 90 degrees indicating a direction due east, 180 degrees indicating a direction due south, 270 degrees indicating a direction due west, etc.)

For reference, the state information of a moving object may include variable state information (e.g., speed, acceleration, position, orientation, velocity, distance to other objects, braking status, yaw rate, or trajectory, etc.) of the moving object and fixed state information (e.g., size, weight, wheelbase, tire characteristics, maximum speed, maximum acceleration, sensor placement, or structural dimensions, etc.) of the moving object.

In this case, the variable state information of a moving object may include information that may vary depending on the movement of the moving object, and may include, for example, at least part of current location information of the moving object and current heading information (e.g., heading angle, yaw rate, velocity vector, trajectory prediction, lane position/orientation, lateral displacement, curvature of path, angular velocity, drift angle, etc.) of the moving object.

Moreover, the fixed state information of a moving object may include information that is not affected by the movement of the moving object, and may include, for example, at least some of length information (a wheelbase length or an overall length) of the moving object and maximum steering angle information of the moving object.

For example, in S110, the point generation device may set a plurality of first azimuth conditions with reference to minimum turning radius information, which is calculated based on fixed state information, and variable state information and may generate a plurality of first candidate sample points that satisfy the plurality of first azimuth conditions and the separation distance condition.

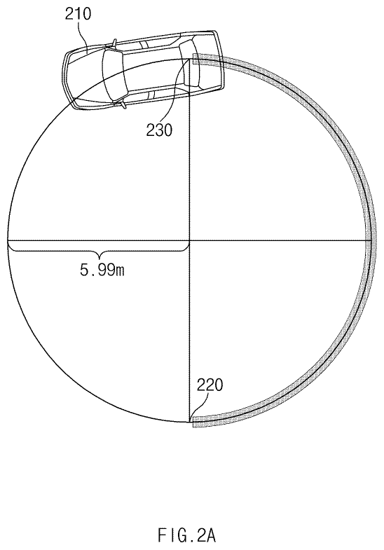

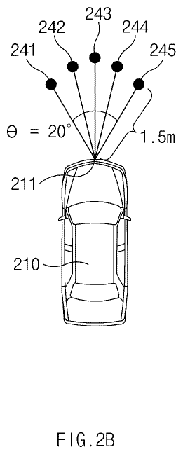

Below, the plurality of first azimuth conditions and the separation distance condition will be described in more detail with reference to FIGS. 2A and 2B.

FIG. 2A is a diagram illustrating a method for deriving a plurality of candidate sample points corresponding to locations reachable by a moving object 210 based on kinematics.

First of all, if a wheel base length ‘l’ of the moving object 210 is 3 m, the maximum steering angle δ of the moving object is 26.6°, and the moving object rotates at the maximum steering angle, the minimum turning radius R of the moving object may be 5.99 m according to Equation 1 below.

$$δ = {tan}^{- 1} ( l / R ) \qquad [ Equation 1 ]$$

Accordingly, if the moving object 210 turns along the minimum turning radius with the maximum steering angle, as shown in FIG. 2A, a driving distance needs to be at least 5.99*πm (i.e., 18.818 m) such that heading information at an arrival location 230 compared to heading information (e.g., +90°) at a start location 220 changes by −180°. Similarly, the driving distance of at least “5.99*π/180 m” (i.e., 0.1045 m) is used to adjust heading information by 1°. Likewise, the driving distance of at least 5.99*π*10/180 m (1.045 m) is used to adjust the heading information at the arrival location by 10° compared to the heading information at the start location. In other words, heading information may be changed by up to 9.5652° per driving distance of 1 m, and heading information may be changed by up to 14° per driving distance of 1.5 m.

Accordingly, an azimuth condition may be set based on state information of the moving object 210, and a candidate sample point may be generated.

For example, because heading information of up to 14° per separation distance of 1.5 m is capable of being changed, the point generation device may generate 5 candidate sample points that satisfy a condition of a separation distance (e.g., 1.5 m) within the angular range of −14° to +14° based on a specific point (e.g., the center point of a front bumper) of a moving object (e.g., a vehicle). For example, the plurality of azimuth conditions may be −14°, −7°, 0°, 7°, and 14°, based on a specific point of the moving object.

However, a safety margin may be set considering that the level of 140 is a heading information level capable of being changed to the maximum while the moving object moves a separation distance of 1.5 m.

For example, as shown in FIG. 2B, the point generation device may generate five candidate sample points 241 to 245 that satisfy the condition of the separation distance (e.g., 1.5 m) within the angle range of −10° to +100 based on a front specific point 211 of the moving object 210. For example, the plurality of azimuth conditions may be −10°, −5°, 0°, 5°, and 10° based on a specific point of the moving object.

For reference, the specific separation distance and specific angle range described above are only examples to aid understanding. The method disclosed in this specification is not limited to the examples.

For reference, the current heading information of the moving object 210 is a value updated depending on the movement of the moving object, and is a concept distinct from an azimuth under the azimuth condition described above. For example, if the moving object moves to a candidate sample point corresponding to 5° among −10°, −5°, 0°, 5°, and 10° set under the azimuth condition in a state where immediately preceding heading information of the moving object is 50°, the heading information of the moving object may be updated to be changed to 55°.

Moreover, if a plurality of first candidate sample points are generated in S110, the point selection device may select a first specific candidate sample point, which satisfies an optimal sample point condition, from among the first candidate sample points as a first optimal sample point with reference to information (e.g., a location or coordinates of a goal point) corresponding to a goal point and information (e.g., a location or coordinates of each first candidate sample point, heading information of the moving object if the moving object reaches each first candidate sample point, or the like) corresponding to the first candidate sample point (S120).

For example, in S120, the point selection device may assign a score to each of the plurality of first candidate sample points with reference to first direction information (e.g., heading, azimuth, steering angle, lane positioning, turn signal indicators, path planning vector, yaw rate, obstacle avoidance vectors, GPS directional data, and road curvature information) from the plurality of first candidate sample points to the goal point and heading information (e.g., heading angle, yaw rate, velocity vector, trajectory prediction, lane position/orientation, lateral displacement, curvature of path, angular velocity, drift angle, etc.) at each of the plurality of first candidate sample point, and may select the first optimal sample point with reference to the score assigned to each of the plurality of first candidate sample points.

For example, the point selection device may select the first optimal sample point based on a candidate sample point, which is reached by the moving object, from among the plurality of first candidate sample points to include heading information closer to first direction information to the goal point.

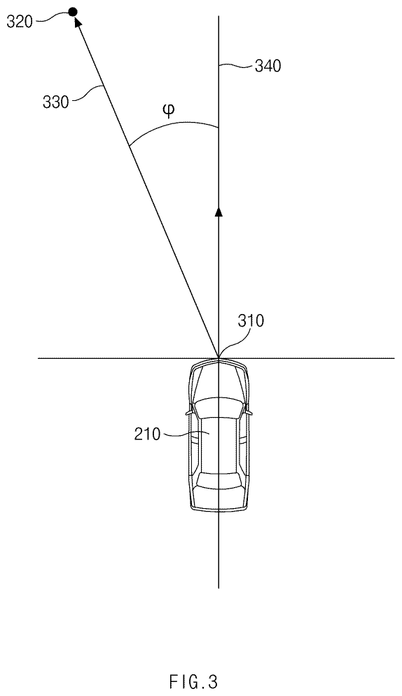

FIG. 3 shows an example of a method in which a point selection device assigns a score to each candidate sample point.

Referring to FIG. 3, if the moving object 210 reaches one point 310 of a plurality of first candidate sample points, a point selection device may assign a score to the corresponding first candidate sample point 310 with reference to first direction information 330 from the first candidate sample point 310 to a goal point 320, and heading information 340 at the first candidate sample point 310.

For example, the point selection device substitutes an angle difference φ between the heading information 340 and the first direction information 330 at the first candidate sample point 310 into Equation 2 below and may derive the score of the first candidate sample point 310.

$$Score = \vert cos ( φ ) \vert \qquad [ Equation 2 ]$$

In this case, the point selection device may select the first optimal sample point with further reference to whether the moving object collides with an obstacle if moving to each candidate sample point.

For example, in S120, the point selection device may select the first optimal sample point, which additionally satisfies a first free space region condition calculated by using state information of the moving object.

For example, it is assumed that the score of the leftmost candidate sample point 241 among the five candidate sample points 241 to 245 shown in FIG. 2B is highest (i.e., the case where heading information at a point in time at which a moving object moves to the corresponding candidate sample point 241 is closer to the first direction information to the goal point).

If the moving object 210 moves to the remaining four candidate sample points 242 to 245 excluding the leftmost candidate sample point 241, a collision situation does not occur (i.e., if the free space region condition is satisfied as the case that the four corresponding sample points are located inside a free space region). On the other hand, a collision situation occurs if the moving object 210 moves to the leftmost candidate sample point 241 (i.e., if the free space region condition is not satisfied as the case that the sample point is located outside the free space region or on its border), the point selection device may select the sample point with the highest score among the remaining four candidate sample points 242 to 245 as the optimal sample point.

In other words, to prevent collision situations of the moving object 210 even though the leftmost candidate sample point 241 includes the highest score, the point selection device may not select the candidate sample point 241 as the optimal sample point.

For reference, a method for detecting a free space region where a moving object is capable of driving may be easily understood by those skilled in the art, and thus detailed descriptions are omitted in this specification.

Besides, if the first optimal sample point is selected in S120, the point generation device may generate a plurality of second candidate sample points, which satisfy a plurality of second azimuth conditions and a separation distance condition set based on state information updated based on the first optimal sample point (S130).

For example, in S130, the point generation device may set a plurality of second azimuth conditions with reference to minimum turning radius information, which is calculated based on fixed state information, and variable state information and may generate a plurality of second candidate sample points that satisfy the plurality of second azimuth conditions and the separation distance condition. For reference, redundant descriptions will be omitted for content that is the same/similar to the content described with reference to in S110 and S120.

Moreover, if a plurality of second candidate sample points are generated in S130, the point selection device may select a second specific candidate sample point, which satisfies an optimal sample point condition, from among the second candidate sample points as a second optimal sample point with reference to information corresponding to a goal point and information corresponding to the second candidate sample point (S140).

For example, in S140, the point selection device may assign a score to each of the plurality of second candidate sample points with reference to second direction information from the plurality of second candidate sample points to the goal point and heading information at each of the plurality of second candidate sample point, and may select the second optimal sample point with reference to the score assigned to each of the plurality of second candidate sample points.

For example, in S140, the point selection device may select the second optimal sample point, which additionally satisfies a second free space region condition calculated by using state information of the moving object.

In the meantime, in S140, all candidate sample points (e.g., the plurality of second candidate sample points) generated by the point generation device may not satisfy the free space region condition. In this case, the process may be performed to return to the previous optimal point selection step, to select the next-ranked sample point (e.g., the first candidate sample point with second priority) as an optimal sample point (e.g., the first optimal sample point), to generate the corresponding candidate sample points (e.g., a plurality of second candidate sample points), and to determine whether the free space region condition is satisfied.

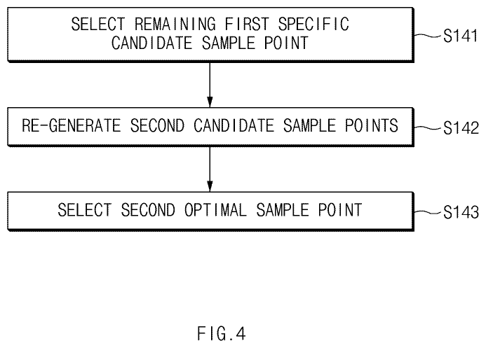

This will be described with reference to FIG. 4. For convenience, FIG. 4 is described by way of an example in which the steps are performed by a processor (e.g., circuit). One, some, or all steps of the example method of FIG. 4, or portions thereof, may be performed by one or more other circuits. One or some, steps of the example method of FIG. 4 may be omitted, performed in other orders, and/or otherwise modified, and/or one or more additional steps may be added.

For example, in S141, if it is determined that there is no second specific candidate sample point, which satisfies the second free space region condition, from among the second candidate sample points, a point selection device may select, as the first optimal sample point, the remaining first specific candidate sample point, which satisfies the optimal sample point condition (e.g., the sample point condition that needs to include the highest score) and the first free space region condition, among the remaining first candidate sample points excluding the first specific candidate sample point (i.e., a sample point selected as the first optimal sample point in the immediately-preceding step) from the first candidate sample point.

Besides, in S142, the point generation device may re-generate the plurality of second candidate sample points, which satisfy the plurality of second azimuth conditions and the separation distance condition set based on state information updated based on the first optimal sample point.

Moreover, in S143, the point selection device may select the second specific candidate sample point, which satisfies the optimal sample point condition and the second free space region condition, from among the second candidate sample points as a second optimal sample point with reference to information corresponding to a goal point and information corresponding to the second candidate sample point.

Furthermore, the optimal sample point selection process described above may be repeated up to a region adjacent to the goal point. Below, it will be described that a final optimal sample point is selected. For reference, the second candidate sample point is described as an example of the finally generated candidate sample point, but an example disclosed in this specification is not limited thereto.

For example, if at least some of candidate sample points are located within a predetermined region set based on the location of a goal point, and a difference between heading information of at least some of the candidate sample points and heading information corresponding to the goal point is within a threshold range, the sampling process may be terminated.

For example, in S140, the point selection device may select the second optimal sample point, which satisfies the optimal sample point condition, from among the second candidate sample points based on the result of determining that at least some of a plurality of second candidate sample points are located within a predetermined region set based on the location of the goal point, and determining whether the heading difference value between heading information at at least some of a plurality of second candidate sample points and heading information corresponding to the goal point is within the threshold range.

For reference, the predetermined region set based on the location of the goal point may be a region within a predetermined radius from the location of the goal point, but is not limited thereto.

Moreover, the heading information corresponding to the goal point means heading information about a goal, at which the moving object needs to look if arriving at the goal point or its adjacent region. For example, if the heading information of the moving object is −90° at a point in time at which the moving object arrives at the goal point or its adjacent region in a state where heading information corresponding to the goal point is set to −30°, and the threshold range of the heading difference value is set to −15° to 15°, the heading difference value is 60°, and thus this corresponds to the case where the threshold range is not satisfied. This means that the moving object is looking in the wrong direction at a point in time at which the moving object arrives at the goal point. For another example, if the heading information of the moving object is −40° at a point in time at which the moving object arrives at the goal point or its adjacent region, the heading difference value is 10°, and thus this corresponds to the case where the threshold range is satisfied. This means that the moving object is facing a desirable direction corresponding to the goal direction at a point in time at which the moving object arrives at the goal point.

For example, it is assumed that the five candidate sample points 241 to 245 shown in FIG. 2B are the second candidate sample points as last generated sample points, heading information corresponding to the goal point is 35°, and the threshold range is set to a range between −6° and 6. If the two second candidate sample points 241 and 242 among the five second candidate sample points 241 to 245 are located within a predetermined region, and heading information at the one second candidate sample point 245 is 30°, the heading difference value of 5° is within the threshold range, and thus the point selection device may select a point, which satisfies the optimal sample point condition (i.e., the condition that it includes the highest score), from among the two second candidate sample points 241 and 242 located within the predetermined region as the second optimal sample point.

For another example, if the two second candidate sample points 241 and 242 are located within the predetermined region, and the heading difference value at the one second candidate sample point 245 is within the threshold range, the point selection device may select a point, which satisfies the optimal sample point condition (i.e., the condition that it includes the highest score), from among the five second candidate sample points 241 to 245 as the second optimal sample point.

For still another example, if the two second candidate sample points 241 and 242 are located within the predetermined region, and heading information at the second candidate sample point 241 among the two sample points located within the predetermined region is 30°, the heading difference value of 5° is within the threshold range, and thus the point selection device may select a point, which satisfies the optimal sample point condition (i.e., the condition that it includes the highest score), from among the two second candidate sample points 241 and 242 located within the predetermined region as the second optimal sample point.

For yet another example, if the two second candidate sample points 241 and 242 are located within the predetermined region, and the heading difference value at the one second candidate sample point 241 is within the threshold range, the point selection device may select a point, which satisfies the optimal sample point condition (i.e., the condition that it includes the highest score), from among the five second candidate sample points 241 to 245 as the second optimal sample point.

In the meantime, there may not be a candidate sample point whose heading difference value is within the threshold range. In this case, the process may be performed to return to the previous optimal point selection step, to select the next-ranked sample point (e.g., the first candidate sample point with second priority) as an optimal sample point (e.g., the first optimal sample point), to generate the corresponding candidate sample points (e.g., a plurality of second candidate sample points), and to determine whether the heading difference value satisfies the threshold range.

For example, if the heading difference value is outside the threshold range, the point selection device may reselect a remaining first specific candidate sample point, which satisfies the optimal sample point condition, from among the remaining first candidate sample points excluding the first specific candidate sample point from the first candidate sample points as the first optimal sample point.

Besides, the point generation device may re-generate the plurality of second candidate sample points, which satisfy the plurality of second azimuth conditions and the separation distance condition set based on state information updated based on the first optimal sample point.

The point selection device may select the second optimal sample point, which satisfies the optimal sample point condition, from among the second candidate sample points based on the result of re-determining that at least some of a plurality of second candidate sample points are located within a predetermined region, and re-determining whether the heading difference value is within the threshold range.

For reference, for convenience of description, (i) a process of determining whether a free space region condition is satisfied, and (ii) a process of determining whether a heading difference value with a goal point satisfies a threshold range are described separately from each other, but the two processes may be compatible with each other.

For example, the point selection device may determine whether the free space region condition is satisfied with respect to a candidate sample point. If at least some of the candidate sample points are located in a predetermined region set based on the goal point location, the point selection device may also determine whether the heading difference value with the goal point satisfies a threshold range.

Moreover, if the second optimal sample point is selected in S140, a route generation device may generate a driving route based on an optimal sample point group including the first optimal sample point and the second optimal sample point (S150).

In other words, if a plurality of optimal sample points are created and selected depending on the process described above, the route generation device may generate a driving route based on a plurality of optimal sample points. For example, the route generation device may generate a B-Spline based on a plurality of optimal sample points, and may output a driving route based on the B-Spline.

Also, if a driving route is created in S150, the vehicle control device may control a vehicle based on the driving route (S160).

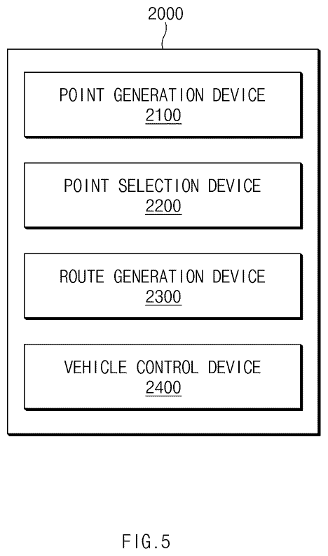

FIG. 5 is a block diagram schematically showing a vehicle control apparatus 2000, according to an example disclosed in this specification.

Referring to FIG. 5, a vehicle control apparatus 2000 according to an example disclosed in the specification may include a point generation device 2100, a point selection device 2200, a route generation device 2300, and a vehicle control device 2400.

For example, the point generation device 2100 may generate a plurality of first candidate sample points that satisfies a plurality of first azimuth conditions and a separation distance condition, which are set based on state information of a moving object. Moreover, the point generation device 2100 may generate a plurality of second candidate sample points, which satisfy a plurality of second azimuth conditions and a separation distance condition set based on state information updated based on the first optimal sample point selected from a first candidate sample point.

Furthermore, the point selection device 2200 may select a first specific candidate sample point, which satisfies an optimal sample point condition, from among a first candidate sample point as a first optimal sample point with reference to information corresponding to a goal point and information corresponding to the first candidate sample point. Furthermore, the point selection device 2200 may select a second specific candidate sample point, which satisfies an optimal sample point condition, from among a second candidate sample point as a second optimal sample point with reference to the information corresponding to the goal point and information corresponding to the second candidate sample point.

In addition or alternative, the route generation device 2300 may generate a driving route based on an optimal sample point group including the first optimal sample point and the second optimal sample point.

Also, the vehicle control device 2400 may control a vehicle based on the driving route.

According to the vehicle control method disclosed in the specification, without using a dynamic memory such as a tree and/or graph, the driving route may be created by using a sampling method based on region information in which the vehicle is capable of being driven, and a smooth driving route may be created.

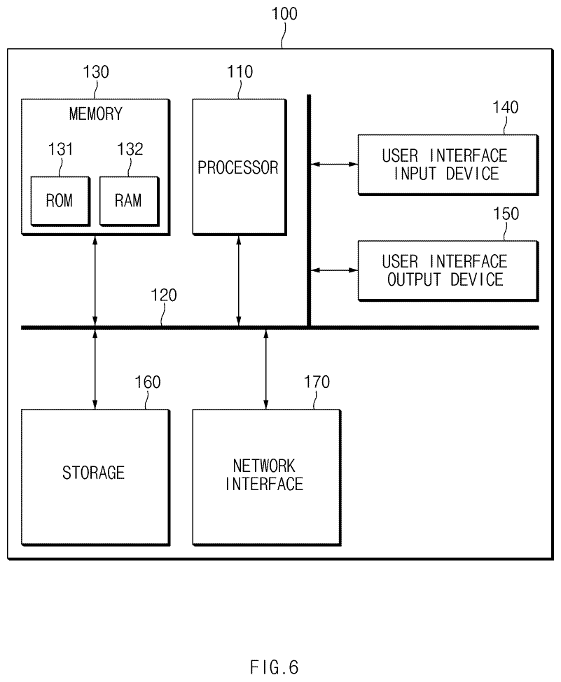

FIG. 6 shows an example of a computing system for executing a vehicle control method, according to an example of the present disclosure.

Referring to FIG. 6, a computing system 1000 may include at least one processor 1100, a memory 1300, a user interface input device 1400, a user interface output device 1500, storage 1600, and a network interface 1700, which are connected with each other via a bus 1200.

The processor 1100 may be a central processing device (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the processes of the method or algorithm described in relation to the examples of the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, solid state drive (SSD), a detachable disk, or a CD-ROM. The exemplary storage medium is coupled to the processor 1100, and the processor 1100 may read information from the storage medium and may write information in the storage medium. In another method, the storage medium may be integrated with the processor 1100. The processor 1100 and the storage medium may reside in an application specific integrated circuit (ASIC). The ASIC may reside in a user terminal. In another method, the processor 1100 and the storage medium may reside in the user terminal as an individual component.

The present disclosure was made to solve the above-mentioned problems occurring in the prior art while advantages achieved by the prior art are maintained intact.

An example of the present disclosure provides a vehicle control method for generating a driving route without precise map information, and an apparatus thereof.

An example of the present disclosure provides a vehicle control method for generating a driving route based on points sampled in consideration of kinematics, and an apparatus thereof.

An example of the present disclosure provides a vehicle control method for generating a smooth driving route without colliding with objects present around a moving vehicle, and an apparatus thereof.

The technical problems to be solved by the present disclosure are not limited to the aforementioned problems, and any other technical problems not mentioned herein will be clearly understood from the following description by those skilled in the art to which the present disclosure pertains.

According to an example of the present disclosure, a vehicle control method may include generating, by a point generation device, a plurality of first candidate sample points satisfying a plurality of first azimuth conditions and a separation distance condition, which are set based on state information of a moving object, selecting, by a point selection device, a first specific candidate sample point, which satisfies an optimal sample point condition, from among the first candidate sample points as a first optimal sample point with reference to information corresponding to a goal point and information corresponding to the first candidate sample points, generating, by the point generation device, a plurality of second candidate sample points satisfying a plurality of second azimuth conditions and the separation distance condition, which are set based on state information updated based on the first optimal sample point, selecting, by the point selection device, a second specific candidate sample point satisfying the optimal sample point condition, from among the second candidate sample points as a second optimal sample point with reference to the information corresponding to the goal point and information corresponding to the second candidate sample points, generating, by a route generation device, a driving route based on an optimal sample point group including the first optimal sample point and the second optimal sample point, and controlling, by a vehicle control device, a vehicle based on the driving route.

In an example, the state information of the moving object may include variable state information and fixed state information, the variable state information may include location information of the moving object and heading information of the moving object, and the fixed state information may include length information of the moving object and maximum steering angle information of the moving object.

In an example, the generating of the plurality of first candidate sample points may include setting, by the point generation device, the plurality of first azimuth conditions with reference to minimum turning radius information, which is calculated based on the fixed state information, and the variable state information. The generating of the plurality of second candidate sample points may include setting, by the point generation device, the plurality of second azimuth conditions with reference to the minimum turning radius information, which is calculated based on the fixed state information, and the variable state information.

In an example, the selecting of the first optimal sample point may include assigning, by the point selection device, a score to each of the plurality of first candidate sample points with reference to first direction information from the plurality of first candidate sample points to the goal point and heading information at each of the plurality of first candidate sample points, and selecting the first optimal sample point with reference to the score assigned to each of the plurality of first candidate sample points. The selecting of the second optimal sample point may include assigning, by the point selection device, a score to each of the plurality of second candidate sample points with reference to second direction information from the plurality of second candidate sample points to the goal point and heading information at each of the plurality of second candidate sample points, and selecting the second optimal sample point with reference to the score assigned to each of the plurality of second candidate sample points.

In an example, the selecting of the first optimal sample point may include selecting, by the point selection device, the first optimal sample point, which additionally satisfies a first free space region condition calculated by using the state information of the moving object. The selecting of the second optimal sample point may include selecting, by the point selection device, the second optimal sample point, which additionally satisfies a second free space region condition calculated by using the state information of the moving object.

In an example, if it is determined that a second specific candidate sample point, which satisfies the second free space region condition, from among the second candidate sample points is not present, the selecting of the second optimal sample point may include reselecting, by the point selection device, a remaining first specific candidate sample point, which satisfies the optimal sample point condition and the first free space region condition, from among remaining first candidate sample points excluding the first specific candidate sample point from the first candidate sample points as the first optimal sample point, re-generating, by the point generation device, the plurality of second candidate sample points satisfying the plurality of second azimuth conditions and the separation distance condition, which are set based on the state information updated based on the first optimal sample point, and selecting, by the point selection device, the second specific candidate sample point satisfying the optimal sample point condition and the second free space region condition, from among the second candidate sample points as the second optimal sample point with reference to the information corresponding to the goal point and the information corresponding to the second candidate sample points.

In an example, the selecting of the second optimal sample point may include selecting, by the point selection device, the second optimal sample point, which satisfies the optimal sample point condition, from among the second candidate sample points based on a result of determining whether at least some of the plurality of second candidate sample points are located within a predetermined region set based on a location of the goal point, and a heading difference value between heading information at at least some of the plurality of second candidate sample points and heading information corresponding to the goal point is within a threshold range.

In an example, if the heading difference value is outside the threshold range, the selecting of the second optimal sample point may include reselecting, by the point selection device, a remaining first specific candidate sample point, which satisfies the optimal sample point condition, from among remaining first candidate sample points excluding the first specific candidate sample point from the first candidate sample points as the first optimal sample point, re-generating, by the point generation device, the plurality of second candidate sample points satisfying the plurality of second azimuth conditions and the separation distance condition, which are set based on the state information updated based on the first optimal sample point, and selecting, by the point selection device, the second optimal sample point, which satisfies the optimal sample point condition, from among the second candidate sample points based on a result of re-determining whether at least some of the plurality of second candidate sample points are located within the predetermined region, and the heading difference value is within the threshold range.

According to an example of the present disclosure, an apparatus may include a point generation device that generates a plurality of first candidate sample points satisfying a plurality of first azimuth conditions and a separation distance condition, which are set based on state information of a moving object, and generates a plurality of second candidate sample points satisfying a plurality of second azimuth conditions and the separation distance condition, which are set based on state information updated based on a first optimal sample point, a point selection device that selects a first specific candidate sample point, which satisfies an optimal sample point condition, from among the first candidate sample points as the first optimal sample point with reference to information corresponding to a goal point and information corresponding to the first candidate sample points, and selects a second specific candidate sample point satisfying the optimal sample point condition, from among the second candidate sample points as a second optimal sample point with reference to the information corresponding to the goal point and information corresponding to the second candidate sample points, a route generation device that generates a driving route based on an optimal sample point group including the first optimal sample point and the second optimal sample point, and a vehicle control device that controls a vehicle based on the driving route.

In an example, the state information of the moving object may include variable state information and fixed state information, the variable state information may include location information of the moving object and heading information of the moving object, and the fixed state information may include length information of the moving object and maximum steering angle information of the moving object.

In an example, the point generation device may set the plurality of first azimuth conditions and the plurality of second azimuth conditions with reference to minimum turning radius information, which is calculated based on the fixed state information, and the variable state information.

In an example, the point selection device may assign a score to each of the plurality of first candidate sample points with reference to first direction information from the plurality of first candidate sample points to the goal point and heading information at each of the plurality of first candidate sample points, and select the first optimal sample point with reference to the score assigned to each of the plurality of first candidate sample points, and may assign a score to each of the plurality of second candidate sample points with reference to second direction information from the plurality of second candidate sample points to the goal point and heading information at each of the plurality of second candidate sample points, and select the second optimal sample point with reference to the score assigned to each of the plurality of second candidate sample points.

In an example, the point selection device may select the first optimal sample point, which additionally satisfies a first free space region condition calculated by using the state information of the moving object, and may select the second optimal sample point, which additionally satisfies a second free space region condition calculated by using the state information of the moving object.

In an example, if it is determined that a second specific candidate sample point, which satisfies the second free space region condition, from among the second candidate sample points is not present, (1) the point selection device may perform a process of reselecting a remaining first specific candidate sample point, which satisfies the optimal sample point condition and the first free space region condition, from among remaining first candidate sample points excluding the first specific candidate sample point from the first candidate sample points as the first optimal sample point, (2) the point generation device may perform a process of re-generating the plurality of second candidate sample points satisfying the plurality of second azimuth conditions and the separation distance condition, which are set based on the state information updated based on the first optimal sample point, and (3) the point selection device may perform a process of selecting the second specific candidate sample point satisfying the optimal sample point condition and the second free space region condition, from among the second candidate sample points as the second optimal sample point with reference to the information corresponding to the goal point and the information corresponding to the second candidate sample points.

In an example, the point selection device may select the second optimal sample point, which satisfies the optimal sample point condition, from among the second candidate sample points based on a result of determining whether at least some of the plurality of second candidate sample points are located within a predetermined region set based on a location of the goal point, and a heading difference value between heading information at at least some of the plurality of second candidate sample points and heading information corresponding to the goal point is within a threshold range.

In an example, if the heading difference value is outside the threshold range, (1) the point selection device may reselect a remaining first specific candidate sample point, which satisfies the optimal sample point condition, from among remaining first candidate sample points excluding the first specific candidate sample point from the first candidate sample points as the first optimal sample point, (2) the point generation device may re-generate the plurality of second candidate sample points satisfying the plurality of second azimuth conditions and the separation distance condition, which are set based on the state information updated based on the first optimal sample point, and (3) the point selection device may select the second optimal sample point, which satisfies the optimal sample point condition, from among the second candidate sample points based on a result of re-determining whether at least some of the plurality of second candidate sample points are located within the predetermined region, and the heading difference value is within the threshold range.

Hereinabove, although the present disclosure has been described with reference to examples and the accompanying drawings, the present disclosure is not limited thereto, but may be variously modified and altered by those skilled in the art to which the present disclosure pertains without departing from the spirit and scope of the present disclosure claimed in the following claims.

Therefore, the examples of the present disclosure are provided to explain the spirit and scope of the present disclosure, but not to limit them, so that the spirit and scope of the present disclosure is not limited by the examples. The scope of the present disclosure should be construed on the basis of the accompanying claims, and all the technical ideas within the scope equivalent to the claims should be included in the scope of the present disclosure.

The above description is merely an example of the technical idea of the present disclosure, and various modifications and modifications may be made by one skilled in the art without departing from the essential characteristic of the present disclosure. Accordingly, examples of the present disclosure are intended not to limit but to explain the technical idea of the present disclosure, and the scope and spirit of the present disclosure is not limited by the above examples. The scope of protection of the present disclosure should be construed by the attached claims, and all equivalents thereof should be construed as being included within the scope of the present disclosure.

According to an example of the present disclosure, it is possible to provide a vehicle control method for generating a driving route without precise map information, and an apparatus thereof.

According to an example of the present disclosure, it is possible to provide a vehicle control method for generating a driving route based on points sampled in consideration of kinematics, and an apparatus thereof.

According to an example of the present disclosure, it is possible to provide a vehicle control method for generating a smooth driving route without colliding with objects present around a moving vehicle, and an apparatus thereof.

Besides, a variety of effects directly or indirectly understood through the present disclosure may be provided.

Hereinabove, although the present disclosure was described with reference to examples and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A method performed by an apparatus of a vehicle, the method comprising:
generating, based on state information of a moving object, a plurality of first candidate sample points, wherein the plurality of first candidate sample points satisfy a plurality of first azimuth conditions and a separation distance condition, and wherein the plurality of first azimuth conditions and the separation distance condition are set based on the state information of the moving object;
based on an optimal sample point condition, information related to a goal point, and information related to the plurality of first candidate sample points, selecting a first optimal sample point from the plurality of first candidate sample points, wherein the first optimal sample point satisfies the optimal sample point condition;
generating, based on the first optimal sample point, a plurality of second candidate sample points, wherein the plurality of second candidate sample points satisfy a plurality of second azimuth conditions and the separation distance condition, wherein the plurality of second azimuth conditions and the separation distance condition are set based on updated state information, and wherein the updated state information is obtained by updating, based on the first optimal sample point, the state information of the moving object;
based on the optimal sample point condition, the information related to the goal point, and information related to the plurality of second candidate sample points, selecting a second optimal sample point from the plurality of second candidate sample points, wherein the second optimal sample point satisfies the optimal sample point condition;
generating, based on the first optimal sample point and the second optimal sample point, a driving route; and
controlling, based on the driving route, the vehicle for autonomous driving.

2. The method of claim 1, wherein the state information of the moving object comprises:
variable state information, wherein the variable state information comprises location information of the moving object and heading information of the moving object, and
fixed stat information, wherein the fixed state information comprises length information of the moving object and maximum steering angle information of the moving object.

3. The method of claim 2, wherein the generating the plurality of first candidate sample points comprises:
setting the plurality of first azimuth conditions with reference to turning radius information, wherein the turning radius information is determined based on the fixed state information and the variable state information, and
wherein the generating the plurality of second candidate sample points comprises:
setting the plurality of second azimuth conditions with reference to the turning radius information.

4. The method of claim 1, wherein the selecting the first optimal sample point comprises:
based on first directional information from the plurality of first candidate sample points to the goal point and first heading information at each of the plurality of first candidate sample points, assigning a score to each of the plurality of first candidate sample points; and
selecting, based on the score assigned to each of the plurality of first candidate sample points, the first optimal sample point, and
wherein the selecting the second optimal sample point comprises:
based on second directional information from the plurality of second candidate sample points to the goal point and second heading information at each of the plurality of second candidate sample points, assigning a score to each of the plurality of second candidate sample points; and
selecting, based on the score assigned to each of the plurality of second candidate sample points, the second optimal sample point.

5. The method of claim 1, wherein the selecting the first optimal sample point comprises:
selecting, based on a first free space region condition, the first optimal sample point, wherein the first free space region condition is determined by using the state information of the moving object, and wherein the first optimal sample point satisfies the first free space region condition, and
wherein the selecting the second optimal sample point comprises:
performing one of:
selecting, based on a second free space region condition, the second optimal sample point from the plurality of second candidate sample points, wherein the second free space region condition is determined by using the state information of the moving object, and wherein the second optimal sample point satisfies the second free space region condition; or
selecting a new first optimal sample point from the plurality of the first candidate sample points.

6. The method of claim 5, wherein the selecting the new first optimal sample point comprises:
based on none of the plurality of second candidate sample points satisfying the second free space region condition:
selecting the new first optimal sample point from the plurality of the first candidate sample points, wherein the new first optimal sample point satisfies the optimal sample point condition and the first free space region condition, and wherein the new first optimal sample point is different from the first optimal sample point;
generating a second plurality of second candidate sample points, wherein the second plurality of second candidate sample points satisfy the plurality of second azimuth conditions and a second separation distance condition, wherein the plurality of second azimuth conditions and the second separation distance condition are set based on second updated state information, and wherein the second updated state information is obtained by updating, based on the new first optimal sample point, the state information of the moving object; and
based on the optimal sample point condition, the information related to the goal point, information related to the second plurality of second candidate sample points, and the second free space region condition, selecting a new second optimal sample point from the second plurality of second candidate sample points.

7. The method of claim 1, wherein the selecting the second optimal sample point comprises performing one of:
based on a heading difference value satisfying a threshold range and at least one of the plurality of second candidate sample points being located within a region, selecting the second optimal sample point from the plurality of second candidate sample points, wherein the region is set based on a location of the goal point, and wherein the heading difference value is based on a difference between first heading information at at least one of the plurality of second candidate sample points and second heading information at the goal point; or
based on the heading difference value not satisfying the threshold range, selecting a new first optimal sample point from the plurality of first candidate sample points.

8. The method of claim 7, wherein the selecting the new first optimal sample point comprises:
selecting the new first optimal sample point from the plurality of first candidate sample points, wherein the new first optimal sample point satisfies the optimal sample point condition, and wherein the new first optimal sample point is different from the first optimal sample point;
generating a second plurality of second candidate sample points, wherein the second plurality of second candidate sample points satisfy the plurality of second azimuth conditions and a second separation distance condition, wherein the plurality of second azimuth conditions and the second separation distance condition are set based on second updated state information, and wherein the second updated state information is obtained by updating, based on the new first optimal sample point, the state information of the moving object; and
based on the optimal sample point condition, at least one of the second plurality of second candidate sample points being located within the region, and a new heading difference value satisfying the threshold range, selecting a second optimal sample point from the second plurality of second candidate sample points, wherein the new heading difference value is based on a difference between new first heading information at at least one of the second plurality of second candidate sample points and the second heading information at the goal point.

9. The method of claim 1, wherein the plurality of first azimuth conditions comprise at least one of −14°, −10°, −7°, 5°, 0°, 5°, 7°, 10°, or 14°.

10. The method of claim 1, wherein the separation distance condition comprises a separation distance that the moving object moves from the vehicle.

11. An apparatus of a vehicle, the apparatus comprising:
one or more processors; and
memory storing instructions, when executed by the one or more processors, cause the apparatus to:
generate, based on state information of a moving object, a plurality of first candidate sample points, wherein the plurality of first candidate sample points satisfy a plurality of first azimuth conditions and a separation distance condition, and wherein the plurality of first azimuth conditions and the separation distance condition are set based on the state information of the moving object;
generate, based on state information updated based on a first optimal sample point, a plurality of second candidate sample points, wherein the plurality of second candidate sample points satisfy a plurality of second azimuth conditions and the separation distance condition, wherein the plurality of second azimuth conditions and the separation distance condition are set based on updated state information, and wherein the updated state information is obtained by updating, based on the first optimal sample point, the state information of the moving object;
based on an optimal sample point condition, information related to a goal point, and information related to the plurality of first candidate sample points, select the first optimal sample point from the plurality of first candidate sample points, wherein the first optimal sample point satisfies the optimal sample point condition;
based on the optimal sample point condition, the information related to the goal point, and information related to the plurality of second candidate sample points, select a second optimal sample point from the plurality of second candidate sample points, wherein the second optimal sample point satisfies the optimal sample point condition;
generate, based on the first optimal sample point and the second optimal sample point, a driving route; and
control, based on the driving route, the vehicle for autonomous driving.

12. The apparatus of claim 11, wherein the state information of the moving object comprises:
variable state information, wherein the variable state information comprises location information of the moving object and heading information of the moving object, and
fixed stat information, wherein the fixed state information comprises length information of the moving object and maximum steering angle information of the moving object.

13. The apparatus of claim 12, wherein the instructions, when executed by the one or more processors, further cause the apparatus to set the plurality of first azimuth conditions with reference to turning radius information and the plurality of second azimuth conditions with reference to the turning radius information, wherein the turning radius information is determined based on the fixed state information and the variable state information.

14. The apparatus of claim 11, wherein the instructions, when executed by the one or more processors, further cause the apparatus to:
based on first directional information from the plurality of first candidate sample points to the goal point and first heading information at each of the plurality of first candidate sample points, assign a score to each of the plurality of first candidate sample points and select, based on the score assigned to each of the plurality of first candidate sample points, the first optimal sample point; and
based on second directional information from the plurality of second candidate sample points to the goal point and second heading information at each of the plurality of second candidate sample points, assign a score to each of the plurality of second candidate sample points and select, based on the score assigned to each of the plurality of second candidate sample points, the second optimal sample point.

15. The apparatus of claim 11, wherein the instructions, when executed by the one or more processors, further cause the apparatus to:
select, based on a first free space region condition, the first optimal sample point, wherein the first free space region condition is determined by using the state information of the moving object, and wherein the first optimal sample point satisfies the first free space region condition; and
select, based on a second free space region condition, the second optimal sample point from the plurality of second candidate sample points, wherein the second free space region condition is determined by using the state information of the moving object, and wherein the second optimal sample point satisfies the second free space region condition.

16. The apparatus of claim 15, wherein the instructions, when executed by the one or more processors, further cause the apparatus to, based on none of the plurality of second candidate sample points satisfying the second free space region condition:
select a new first optimal sample point from the plurality of the first candidate sample points, wherein the new first optimal sample point satisfies the optimal sample point condition and the first free space region condition, and wherein the new first optimal sample point is different from the first optimal sample point;
generate a second plurality of second candidate sample points, wherein the second plurality of second candidate sample points satisfy the plurality of second azimuth conditions and a second separation distance condition, wherein the plurality of second azimuth conditions and the second separation distance condition are set based on second updated state information, and wherein the second updated state information is obtained by updating, based on the new first optimal sample point, the state information of the moving object; and
based on the optimal sample point condition, the information related to the goal point, information related to the second plurality of second candidate sample points, and the second free space region condition, select a new second optimal sample point from the second plurality of second candidate sample points.

17. The apparatus of claim 11, wherein the instructions, when executed by the one or more processors, further cause the apparatus to, based on a heading difference value satisfying a threshold range and at least one of the plurality of second candidate sample points being located within a region, select the second optimal sample point from the plurality of second candidate sample points, wherein the region is set based on a location of the goal point, and wherein the heading difference value is based on a difference between first heading information at at least one of the plurality of second candidate sample points and second heading information at the goal point.

18. The apparatus of claim 17, wherein the instructions, when executed by the one or more processors, further cause the apparatus to, based on the heading difference value not satisfying the threshold range:
select a new first optimal sample point from the plurality of first candidate sample points, wherein the new first optimal sample point satisfies the optimal sample point condition, and wherein the new first optimal sample point is different from the first optimal sample point;
generate a second plurality of second candidate sample points, wherein the second plurality of second candidate sample points satisfy the plurality of second azimuth conditions and a second separation distance condition, wherein the plurality of second azimuth conditions and the second separation distance condition are set based on second updated state information, and wherein the second updated state information is obtained by updating, based on the new first optimal sample point, the state information of the moving object; and
based on the optimal sample point condition, at least one of the second plurality of second candidate sample points being located within the region, and a new heading difference value satisfying the threshold range, select a second optimal sample point from the second plurality of second candidate sample points, wherein the new heading difference value is based on a difference between new first heading information at at least one of the second plurality of second candidate sample points and the second heading information at the goal point.

19. The apparatus of claim 11, wherein the plurality of first azimuth conditions comprise at least one of −14°, −10°, −7°, −5°, 0°, 5°, 7°, 10°, or 14°.

20. The apparatus of claim 11, wherein the separation distance condition comprises a separation distance that the moving object moves from the vehicle.
